(19) United States
(12) Patent Application Publication
(10) Pub. No.: US 2026/0038483 A1
(43) Pub. Date: Feb. 5, 2026

(54) Accuracy in Already-Trained ASR Models

(71) Applicant: Samsung Electronics Co., Ltd., Suwon-si (KR)

(72) Inventors: Aditya Jajodia, Sunnyvale, CA (US); Taeyeon Ki, Milpitas, CA (US); Divya Neelagiri, Dublin, CA (US); Vijendra Apsingekar, San Jose, CA (US)

(21) Appl. No.: 19/069,865

(22) Filed: Mar. 4, 2025

Related U.S. Application Data
(60) Provisional application No. 63/677,774, filed on Jul. 31, 2024.

(51) Int. Cl. G10L 15/07; G06F 40/232; G10L 15/26

(52) U.S. Cl. CPC G10L 15/075; G06F 40/232; G10L 15/26

(57) ABSTRACT

In one embodiment, a method includes accessing a set of speech-transcription pairs for a particular user, each speech-transcription pair including (1) an audio segment spoken by the user and (2) a transcription prediction of the audio segment determined by a trained ASR model. The method further includes generating, by a first LLM, a corrected transcript that corrects one or more errors in at least some of the transcription predictions; classifying, by a second LLM, each of the speech-transcription pairs into one of a number of predetermined speech categories; selecting, based on an error rate, one or more of the predetermined speech categories; and for each selected speech category, further training the trained ASR model based on (1) a subset of audio segments drawn from the respective predetermined speech category and (2) for each audio segment in the subset, the corresponding corrected transcript generated by the first LLM.

### PRIORITY CLAIM

This application claims the benefit under 35 U.S.C. § 119 of U.S. Provisional Patent Application No. 63/677,774 filed Jul. 31, 2024, which is incorporated by reference herein.

### TECHNICAL FIELD

This application generally relates to techniques for improving accuracy in already trained automatic speech recognition (ASR) models.

### BACKGROUND

Electronic voice assistants receive spoken-word input from users and detect the words in the input (i.e., transcribe the input) to provide some functionality to the user, such as generating a natural-language response to a question or executing a task on a connected device or software application. Robust speech recognition is essential to the proper functioning of voice assistants; otherwise, errors propagate to downstream tasks.

A voice assistant may be integrated with a virtual assistant, also sometimes referred to as a digital assistant or an intelligent assistant, which is a software agent that provides a range of task-performance and other human-assistance services, often in response to user input. For example, a virtual assistant may receive verbal, spoken-word input from a user (e.g., to update a list, schedule a meeting, activate another device, place a call, and so), identify the user's goal from the input, and then identify and perform the tasks to achieve that goal. Virtual assistants often access a suite of specific agents, such as speech-to-text agents and AI agents including large-language models (LLMs), and other software applications such as weather applications, email applications, map applications, etc.

### BRIEF DESCRIPTION OF THE DRAWINGS

FIG. 1 illustrates an example method for improving a trained ASR model.

FIG. 2 illustrates an example implementation of the example method of FIG. 1.

FIG. 3 illustrates an example computing system.

### DESCRIPTION OF EXAMPLE EMBODIMENTS

Automatic speech recognition (ASR) models are used to identify human speech, for example in order to transcribe the speech or as part of a voice assistant that recognizes the speech and provides some functionality (e.g., executing a spoken command, responding to a spoken query, etc.). ASR models are trained prior to deployment, typically by using human graders who listen to an anonymized audio segment of speech (in which the user's identity is masked) and generate a corresponding ground-truth transcription of the speech, at times along with metadata such as “named entity,” “song name,” etc. These audio segment/ground truth pairs are then used to train an ASR to recognize human speech. Because generating such training data is labor intensive, databases containing training data sufficient to train an ASR can be extremely expensive. These supervised training approaches are taken because self-supervised training requires architecture changes to ASR models and would still require training infrastructure for pretraining task. In addition, using many utterances without preprocessing the corresponding audio will introduce errors in the system, and since the data is not of uniform distribution it will lead to overfitting for more frequent utterances.

Trained ASR models typically provide fairly good accuracy, for example some models may provide 95%-96% accuracy in identifying the words spoken in an audio segment. However, inaccuracies in a trained ASR model are difficult to eliminate, in-part because training requires ground-truth transcriptions for the ASR, and generating ground-truth data for ASRs is a labor-intensive process, so it's only feasible to generate thousands of ground-truth labels. In addition, while a trained ASR may subsequently receive thousands of utterances for a particular user (e.g., a voice assistant on a smartphone or other device may receive thousands of utterances for a particular user), this data essentially goes to waste for the purpose of training the model because of the volume of data-typically well under 1% of utterance data is used for ASR model training or improvement. Moreover, at times this real-world usage data stays on device or is otherwise protected, e.g., by user-privacy restrictions, and therefore the data cannot be used in data sets to provide to graders to generate ground truth transcriptions.

These limitations on training and improving ASR models also limit the use of training data across many different pronunciations, accents, dialects, gender, age, and noise environments. For instance, an utterance that is transcribed by an ASR with perfect accuracy in noiseless environments may not be transcribed well in noisy environments (e.g., while leaving an airport, at a grocery store, on a factory floor, etc.), and the number and diversity of real-word noisy environments makes training an ASR using ground-truth labels infeasible, and therefore performance of even a well-trained ASR in such environments is degraded.

In contrast, the techniques described herein automatically improve already-trained ASR models, including by personalizing an ASR to a specific user, based on real-world utterances. The techniques described herein can be used to continually improve a trained ASR after that trained ASR has been released, as described more fully below.

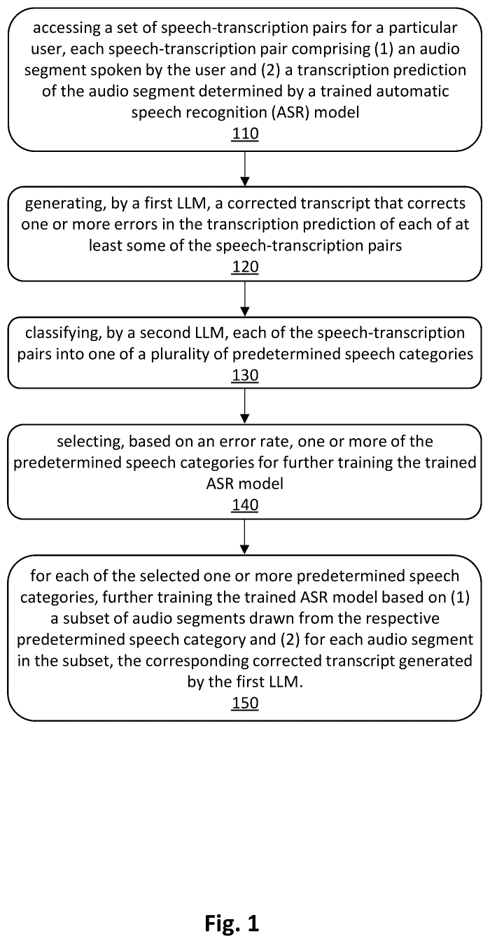

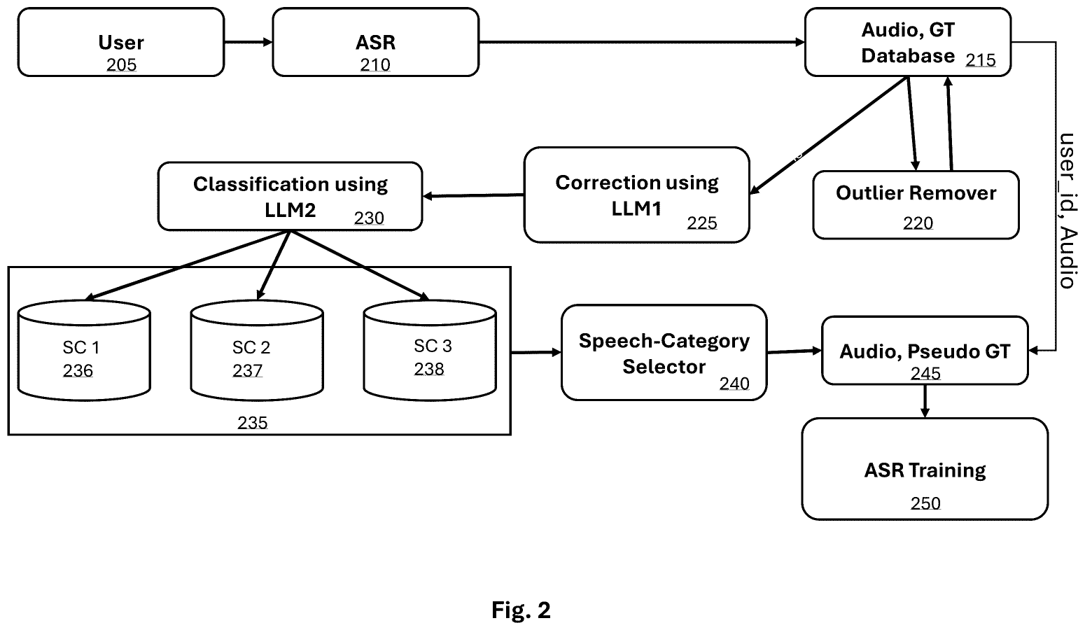

FIG. 1 illustrates an example method for improving a trained ASR model. Step 110 of the example method of FIG. 1 includes accessing a set of speech-transcription pairs for a particular user, where each speech-transcription pair includes (1) an audio segment spoken by the user and (2) a transcription prediction of the audio segment determined by a trained automatic speech recognition (ASR) model. FIG. 2 illustrates an example implementation of the example method of FIG. 1. In the example of FIG. 2, a user 205 provides an utterance to an ASR 210, which may be part of a voice assistant, for example. The ASR transcribes the received utterance in the course of performing its task (e.g., answering a question, converting the spoken utterance to text, etc.). In other words, the utterances provided by user 205 to trained ASR 210 are made in the course of user 205's use of ASR 210, after ASR 210 has been trained and deployed.

Each utterance is stored as a segment of spoken audio along with the ASR transcription of the utterance—which is also referred to as a hypothesis because the ASR is predicting what the correct transcription of the utterance is—in a datastore, such as a database 215 in the example of FIG. 2. In particular embodiments, the data store may be specific to the particular user, i.e., user 205 is identified (e.g., by voice recognition, a user login to a device interfacing or hosting ASR 210, etc.) and the audio segments and corresponding ASR transcriptions are stored in a database particular to that user. In other embodiments, a particular user's identity may be stored in association with that user's utterances and corresponding ASR transcriptions in a shared datastore, e.g., if a device is a shared device such as a smart speaker or a smart TV. In particular embodiments, a data store for a shared device may not differentiate between users of that device, such that each utterance provided to a device hosting or interfacing with an ASR are stored as if such utterance came from the same user of the shared device.

In particular embodiments, the speech-transcription pairs in a data store may be preprocessed before such data is used to improve a trained ASR. For example, the implementation of FIG. 2 illustrates that outlier removal 220 may be used to improve the quality of the speech-transcription pairs in database 215. For instance, outlier removal 220 may remove audio segments having an outlier word density. For example, if a 10-second audio segment has a single word transcribed by ASR 210, then the word density is likely too low for that segment-transcription pair to be useful for ASR improvement. Likewise, if a 1-second audio segment is identified as having 10 words, then that word density is likely too high for that segment-transcription pair to be useful for ASR improvement. In particular embodiments, word density for a transcription prediction may be measured by the number of characters in the prediction divided by the length of the corresponding audio segment. In particular embodiments, an audio segment may be an outlier if its word density is less than 0.5 (i.e., less than 0.5 characters per second) or greater than 25 characters per second.

While the example above illustrates word density as a measure for determining outliers for removal from a data store, this disclosure contemplates that other measures (e.g., noise present in an audio segment) may be used. Outliers in a set of audio segments may be determined based on sorting methods, visualization methods, statistical methods (e.g., z-scores, etc.), or based on an interquartile range, although this disclosure contemplates that other outlier-detection methods may be used.

Step 120 of the example method of FIG. 1 includes generating, by a first LLM, a corrected transcript that corrects one or more errors in the transcription prediction of each of at least some of the speech-transcription pairs. For instance, in the example implementation of FIG. 2, correction using LLM1 in step 225 is used to identify errors in the ASR transcriptions of the speech-transcription pairs in data store 215. In particular embodiments, all of the data in a data store may be passed to the first LLM, while in other embodiments a subset of such data may be used.

Along with the transcription from speech-transcription pairs, a prompt is passed to the first LLM instructing the LLM to identify errors in the transcription and correct the transcription, if necessary. For instance, a prompt may instruct the first LLM to act as a spelling corrector for a hypothesis generated by an ASR. The prompt may instruct the LLM to only correct spelling errors, and not to remove or add words or to provide any other notes or explanation. As another example, a prompt may instruct an LLM to both perform spelling correction and or to add or remove words from a transcription, or to only add or remove words.

In particular embodiments, the first LLM may be finetuned using ground-truth data. For example, the first LLM may be passed ASR transcriptions and manually-generated (by human graders) ground truths for those transcriptions. The first LLM may then be finetuned using this grading data, and after fine tuning may be deployed to improve a trained ASR.

Step 130 of the example method of FIG. 1 includes classifying, by a second LLM, each of the speech-transcription pairs into one of a number of predetermined speech categories. For instance, the example implementation of FIG. 2 provides classification using LLM2 in step 230. To do so, LLM2 takes as input the transcriptions (which LLM1 may have corrected or may have left as-is) output by LLM and then classifies those transcriptions into predetermined speech categories 235 using predetermined labels. In the example of FIG. 2, speech categories 235 include speech category 1 236, speech category 2 237, and speech category 3 238, although more or fewer predetermined speech categories may be used.

LLM 2 may be provided with a prompt instructing the LLM to perform classification. For example, a prompt may instruct LLM2 to act as a sentence classifier and may identify the predetermined categories available to use for classification. The prompt may also provide examples of particular transcriptions and corresponding classifications/speech categories, in order to fine-tune LLM2 to its specific classification task.

Examples of speech categories are “includes named entity,” which is used when a named entity is detected in the transcription; “device setting,” which is used when a user is adjusting a setting on a device (e.g., the user's smartphone) using the ASR; “device application,” which is used to identify transcriptions that correspond to instructions from the user to invoke an application (e.g., a request by the user to call someone, to generate a text or email, to set an alarm, etc.); “quick reply,” which is used to categorize short responses (e.g., “yes”) from a user; “question and answer;” which is used when the transcription corresponds to a question from the user (e.g., “how tall is the tallest mountain in the world?”); “entertainment,” which is used for transcriptions that correspond to entertainment requests from the user (e.g., play music, etc.); and “other,” which is used for transcriptions that don't correspond to any other category. The specific speech categories identified above are merely examples of certain categories that an embodiment may use, and this disclosure that other category types and labels may be used.

Step 140 of the example method of FIG. 1 includes selecting, based on an error rate, one or more of the predetermined speech categories for further training the trained ASR model. For instance, in the example implementation of FIG. 2, speech-category selector 240 identifies which speech categories 235 to draw from for improving ASR 210. In particular embodiment, the error rate may be the word error rate, which tracks the percentage of LLM1's corrections for a particular speech category. The tracked corrections may be the total number of corrections (e.g., the number of corrected word spellings divided by the total number of words, determined for each speech category) or may be the percentage of ASR transcriptions that have been corrected, determined on a per-speech-category basis. Other error-rate metrics may be used, and the error rate is determined on a per-speech-category basis, to identify which type of ASR transcriptions, as categorized by the second LLM, have relatively poorer performance, as determined by LLM 1's corrections.

Step 150 of the example method of FIG. 1 includes for each of the selected one or more predetermined speech categories, further training the trained ASR model based on (1) a subset of audio segments drawn from the respective predetermined speech category and (2) for each audio segment in the subset, the corresponding corrected transcript generated by the first LLM. For instance, as illustrated in the example of FIG. 2, speech-pseudo-ground-truth (PGT) pairs 245 are drawn from a selected speech-category. These speech-PGT pairs are then used to provide additional training to trained ASR 210 in step 250. In particular embodiments, training 250 may be based solely on corrected transcripts output by the first LLM that include changes to the ASR's transcription (i.e., when the transcript output by the first LLM is different than the ASR's transcription prediction). In other embodiments, training on corrected transcripts generated by the first LLM includes transcripts that are changed and transcripts that are not changed (i.e., when the “corrected” transcript output by the first LLM contains no changes to the ASR's transcription prediction).

By creating speech categories and then selecting speech categories to focus on (based on the error rate) for improving a trained ASR, the techniques described herein make efficient use of the many utterances generated by the user.

The example method of FIG. 1 and the example implementation of FIG. 2 may be performed on device side or server side. Different approaches have different tradeoffs and different implementations, as described below.

The example method of FIG. 1 may be implemented on a user's device, e.g., on the same device that hosts ASR 210. As a result, the user's personal data (e.g., the audio segments containing the user's utterances and the transcriptions), the ASR's predicted transcriptions, and the first LLM's corrected transcriptions do not leave the user's device, protecting user privacy while still improving the trained ASR. In addition, on-device implementations can personalize an on-device trained ASR to a particular user, as only the utterances of that user (or users, in some embodiments in which the device is shared) are used to improve the ASR on that device. As a result, while conventional training techniques result in generic ASRs that are rolled out to many users, an on-device implementation takes that well-trained, generic ASR and improves it while personalizing those improvements to a particular user. The method of FIG. 1 may be performed periodically, making the improvements cumulative; for example, over time the ASR is fine-tuned to the specific user's voice, gender, accent, language, dialect, speaking speed, etc.

On-device implementations can also have benefits for a provider of the ASR model (e.g., the entity that releases the trained ASR and subsequent versions). For instance, the provider does not incur the data transmission and storage costs associated with handling many utterances server-side, nor does the provider need to implement specialized data-handling practices, such as privacy restrictions that commonly apply to user vocalizations.

In an on-device implementation, when an ASR is updated to a new version by the provider, then the built-up database of audio segments and corrected transcript pairs (e.g., audio-PGT pairs 245 in the example implementation of FIG. 2) can be used to quickly train the new ASR version, for example in a day or less, adapting the new ASR model to the user's personalization.

The example method of FIG. 1 may be implemented server-side, in particular embodiments. For example, output from many ASRs 210 corresponding to many users 205 may be uploaded to a server, which can store the anonymized speech-transcription pairs for many users. The collective datastore can then be used to improve a server-side ASR. In this example, the improvements are not specific to any particular user, but the improvements do reflect the experiences of many users, resulting in more training data for improving the model. In addition, personalized ASRs require a user to encounter ASR errors in order to generate the corrected transcriptions, while shared ASR implementations provide improved ASR performance to all users, meaning that many users will receive accurate ASR performance in uses cases that would have resulted in errors without the techniques described herein.

In particular embodiments, server-side implementation may be beneficial because such implementations typically host much larger ASR models and LLMs than on-device implementations, resulting in better performance. In server-side implementations, user utterances may be uploaded to a server-side ASR, which transcribes the utterances, or the ASR may be improved server-side and then pushed out to particular devices (i.e., the ASR inference process may be device side while the ASR improvement process may be server-side).

In particular embodiments, a server-side ASR improvement implementation may provide personalized ASR performance to users. For instance, the implementation of FIG. 1 may be implemented server-side. Each user's audio segments are linked with a user ID for that user, and therefore while database 215 may include audio segments from many users, each user's segments are still identifiable for ASR personalization. In personalized server-side implementations, each PGT is associated with the corresponding user's audio segments.

Server-side ASR models have many weights, and therefore it is generally impractical to create an ASR model for each user of a voice assistant. However, each user's audio and pseudo-GTs may be used to finetune a server-side ASR model that serves multiple users. For instance, low-rank adaptation techniques used for large-language models may be adapted to ASR models to determine a user-specific subset of ASR model weights that would personalize the ASR for that user. The server can store the subset of weights for each user, as the subset is much smaller than the full set of weights for an ASR model, and then the server can load general ASR model weights and the user-specific subset of ASR weights when a particular user invokes the ASR in order to serve a personalized ASR for that user.

As server-side ASR models can typically be much larger than device-side ASR models, the techniques described above provide the benefits of server-side delivery while also providing personalized ASR performance.

The techniques described herein improve the performance of an already-trained ASR, and as described above, and many embodiments of this disclosure provide personalized ASR improvements. Moreover, while using LLMs during natural language tasks introduces lag to a system, the techniques described leverage LLMs on user audios to improve the performance of the ASR model itself, without requiring runtime intervention by an LLM to improve otherwise erroneous ASR model output. The ASR techniques described herein also provide a positive feedback loop for users: as users use their ASR the ASR gets better over time, which improves the performance their voice assistance, thereby encouraging further user of the ASR model, which results in even more improvement, etc.

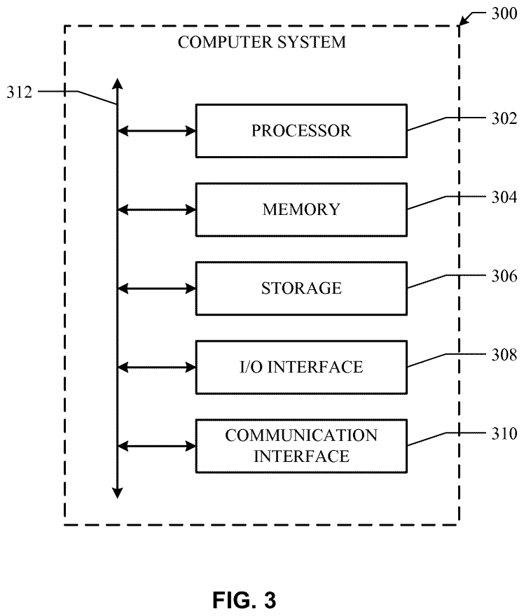

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a set of speech-transcription pairs for a particular user, each speech-transcription pair comprising (1) an audio segment spoken by the user and (2) a transcription prediction of the audio segment determined by a trained automatic speech recognition (ASR) model;
generating, by a first LLM, a corrected transcript that corrects one or more errors in the transcription prediction of each of at least some of the speech-transcription pairs;
classifying, by a second LLM, each of the speech-transcription pairs into one of a plurality of predetermined speech categories;
selecting, based on an error rate, one or more of the predetermined speech categories for further training the trained ASR model; and
for each of the selected one or more predetermined speech categories, further training the trained ASR model based on (1) a subset of audio segments drawn from the respective predetermined speech category and (2) for each audio segment in the subset, the corresponding corrected transcript generated by the first LLM.

2. The method of claim 1, wherein the corrected transcript corrects one or more spelling errors in the transcription prediction of each of the at least some of the speech-transcription pairs.

3. The method of claim 1, wherein the corrected transcript at least one of: (1) adds one or more words to, or (2) removes one or more words from, the transcription prediction of each of the at least some of the speech-transcription pairs.

4. The method of claim 1, further comprising removing, from the set of speech-transcription pairs, one or more outlier pairs.

5. The method of claim 4, further comprising identifying the one or more outlier pairs based on a word density of the respective audio segments in the outlier pairs.

6. The method of claim 1, wherein the method is performed on a client device of the particular user, the client device storing the ASR, the first LLM, and the second LLM.

7. The method of claim 1, wherein:
the method is performed by a server device that hosts the ASR model;
the particular user is one of a plurality of users served by the server device; and
each audio from the plurality of users is anonymized.

8. The method of claim 7, further comprising determining, for each of the plurality of users and based on the further ASR training for each respective user, a subset of user-specific ASR weights that personalize the server-side ASR model.

9. A system comprising:
one or more non-transitory computer readable storage media storing instructions; and one or more processors coupled to the one or more non-transitory computer readable storage media and operable to execute the instructions to:
access a set of speech-transcription pairs for a particular user, each speech-transcription pair comprising (1) an audio segment spoken by the user and (2) a transcription prediction of the audio segment determined by a trained automatic speech recognition (ASR) model;
generate, by a first LLM, a corrected transcript that corrects one or more errors in the transcription prediction of each of at least some of the speech-transcription pairs;
classify, by a second LLM, each of the speech-transcription pairs into one of a plurality of predetermined speech categories;
select, based on an error rate, one or more of the predetermined speech categories for further training the trained ASR model; and
for each of the selected one or more predetermined speech categories, further train the trained ASR model based on (1) a subset of audio segments drawn from the respective predetermined speech category and (2) for each audio segment in the subset, the corresponding corrected transcript generated by the first LLM.

10. The system of claim 9, wherein the corrected transcript corrects one or more spelling errors in the transcription prediction of each of the at least some of the speech-transcription pairs.

11. The system of claim 9, wherein the corrected transcript at least one of: (1) adds one or more words to, or (2) removes one or more words from, the transcription prediction of each of the at least some of the speech-transcription pairs.

12. The system of claim 9, further comprising one or more processors that are operable to execute the instructions to remove, from the set of speech-transcription pairs, one or more outlier pairs.

13. The system of claim 12, further comprising one or more processors that are operable to execute the instructions to identify the one or more outlier pairs based on a word density of the respective audio segments in the outlier pairs.

14. The system of claim 9, wherein the system is part of a client device that stores the ASR, the first LLM, and the second LLM.

15. The system of claim 9, wherein:
the system is part of a server device that hosts the ASR model;
the particular user is one of a plurality of users served by the server device; and
each audio from the plurality of users is anonymized.

16. The system of claim 15, further comprising one or more processors that are operable to execute the instructions to determine, for each of the plurality of users and based on the further ASR training for each respective user, a subset of user-specific ASR weights that personalize the server-side ASR model.

17. One or more non-transitory computer readable storage media storing instructions that are operable when executed by one or more processors to:
access a set of speech-transcription pairs for a particular user, each speech-transcription pair comprising (1) an audio segment spoken by the user and (2) a transcription prediction of the audio segment determined by a trained automatic speech recognition (ASR) model;
generate, by a first LLM, a corrected transcript that corrects one or more errors in the transcription prediction of each of at least some of the speech-transcription pairs;
classify, by a second LLM, each of the speech-transcription pairs into one of a plurality of predetermined speech categories;
select, based on an error rate, one or more of the predetermined speech categories for further training the trained ASR model; and
for each of the selected one or more predetermined speech categories, further train the trained ASR model based on (1) a subset of audio segments drawn from the respective predetermined speech category and (2) for each audio segment in the subset, the corresponding corrected transcript generated by the first LLM.

18. The media of claim 17, wherein the corrected transcript corrects one or more spelling errors in the transcription prediction of each of the at least some of the speech-transcription pairs.

19. The media of claim 17, wherein the corrected transcript at least one of: (1) adds one or more words to, or (2) removes one or more words from, the transcription prediction of each of the at least some of the speech-transcription pairs.

20. The media of claim 17, wherein the instructions are further operable when executed by one or more processors to remove, from the set of speech-transcription pairs, one or more outlier pairs.
